(19) United States
(12) Patent Application Publication
(10) Pub. No.: US 2002/0116629 A1
(43) Pub. Date: Aug. 22, 2002

(54) Apparatus and methods for active avoidance of objectionable content

(75) Inventors: David Frederick Bantz, Chappaqua, NY (US); Quentin A. Gouedard, New York, NY (US)

Correspondence Address: Duke W. Yee, Carstens, Yee & Cahoon, LLP, P. O. Box 802334, Dallas, TX, 75380, US

(73) Assignee: International Business Machines Corporation, Armonk, NY

(21) Appl. No.: 09/788,071

(22) Filed: Feb. 16, 2001

(51) Int. Cl. G06F 11/30

(52) U.S. Cl. 713/200

(57) ABSTRACT

An apparatus and method for active avoidance of objectionable content are provided. The apparatus and method perform analysis of requested content to determine an amount of objectionable content in the requested content. The amount of objectionable content is then compared against one or more thresholds defined in a user profile. Based on the comparison, a determination is made as to whether or not the requested content should be provided to the client device. If the requested content is not provided to the client device, the requested content, or a link to the requested content, is stored in a data structure within the user profile. The data structure may be reviewed at a later time by the user, a parent of the user, an employer of the user, or the like, to determine if the requested content in actuality contains objectionable content. The thresholds defined in the user profile may then be adjusted based on the review of the requested content in the data structure.

### TECHNICAL FIELD

The present invention is directed to an improved distributed computer system. More particularly, the present invention provides apparatus and methods for active avoidance of objectionable content.

### DESCRIPTION OF RELATED ART

With the vast dissemination of information via the Internet and very little ability to control the content of the information received by users, much emphasis has been made on the elimination of objectionable content. The most commonly encountered example is that of the protection of children from content that may be considered obscene, frightening, or repulsive to the child, such as pornography or sites picturing graphically violent scenes. Moreover, content on the Internet may be strongly objectionable to users with strong religious views, especially in some religions where women, for example, are sheltered from such content in everyday life.

The need to protect certain segments of society from objectionable content is contrasted by the desire to provide individuals with the freedom to navigate the Internet unhindered. In order to provide users of the Internet the ability to browse the World Wide Web while protecting certain users from objectionable content, various content elimination devices have been devised.

These content elimination devices typically are of the “site blocking” variety. That is, a list of sites is maintained by a vendor of site blocking software, the sites being presumed to contain objectionable content. Net Nanny, available from Net Nanny Software International of Toronto Canada is an example of such site blocking software.

With such software, the blocking itself is performed by a component of an Internet browser application or proxy server. Maintenance of the site list is very difficult because the correct functioning of the site blocker depends on precise knowledge of all Web sites containing objectionable content, and these sites come and go rapidly on the Web.

More importantly, site blocking does not address the situation where a particular Web site may contain content of value to the end user and may also contain content objectionable to the end user. If such a site is blocked, the valuable content is made unavailable. If the site is not blocked, there is a risk of exposing the end user to objectionable content.

Thus, site blocking has two main drawbacks, over-inclusiveness and under-inclusiveness. Site blocking is over-inclusive in that Web sites that contain valuable content and some marginally objectionable content may be blocked. Site blocking is under-inclusive in that not all Web sites that contain objectionable content may be represented in the list of Web sites that are to be blocked.

Some efforts have been made to address the under-inclusiveness problem of site blocking by providing algorithms that automatically classify content with respect to some known fixed criteria. For example, there are algorithms, such as Internet Safari, available from Hearsoft™ at www.hearsoft.com, that purport to be able to determine if an image on a Web page contains nudity. Such algorithms are inflexible, inaccurate, and suffer from the same over-inclusiveness problem described above. That is, these algorithms would result in blocking a Web page depicting a Reubens nude along with Web pages having pornographic images. Moreover, such algorithms also suffer from under-inclusiveness in that any discrepancy of an image from the known fixed criteria may cause the content to be unblocked. Thus, a nude image with a tattoo may be sufficient to overcome the algorithm and an end user may be presented with objectionable content.

Thus, it would be beneficial to have an apparatus and method for active avoidance of objectionable content that does not suffer from the over-inclusiveness and under-inclusiveness problems of the known systems.

### SUMMARY OF THE INVENTION

The present invention provides an apparatus and method for active avoidance of objectionable content. The apparatus and method perform analysis of requested content to determine an amount of objectionable content in the requested content. The amount of objectionable content is then compared against one or more thresholds defined in a user profile. Based on the comparison, a determination is made as to whether or not the requested content should be provided to the client device. If the requested content is not provided to the client device, the requested content, or a link to the requested content, is stored in a data structure within the user profile. The data structure may be reviewed at a later time by the user, a parent of the user, an employer of the user, or the like, to determine if the requested content in actuality contains objectionable content. The thresholds defined in the user profile may then be adjusted based on the review of the requested content in the data structure.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is an exemplary block diagram illustrating a network data processing system according to one embodiment of the present invention;

FIG. 1B is an exemplary block diagram illustrating a network data processing system according to two other alternative embodiments of the present invention;

FIG. 2 is an exemplary block diagram illustrating a server device according to one embodiment of the present invention;

FIG. 3 is an exemplary block diagram illustrating a client device according to one embodiment of the present invention;

FIG. 4 is an exemplary block diagram illustrating data flow according to one embodiment of the present invention;

FIG. 5 is a flowchart outlining an exemplary operation of the present invention when determining if received content contains objectionable content; and

FIG. 6 is a flowchart outlining an exemplary operation of the present invention when reviewing an objectionable content log.

### DETAILED DESCRIPTION OF THE PREFERRED EMBODIMENT

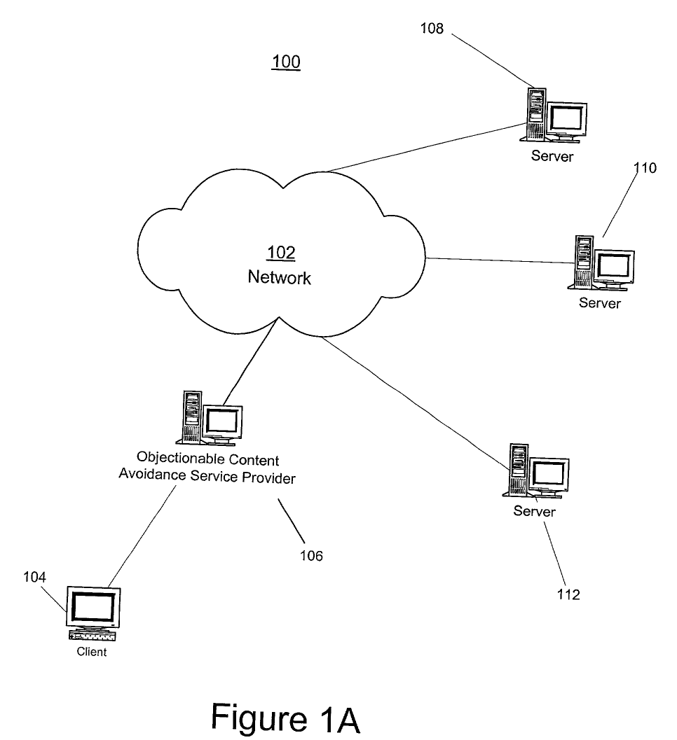

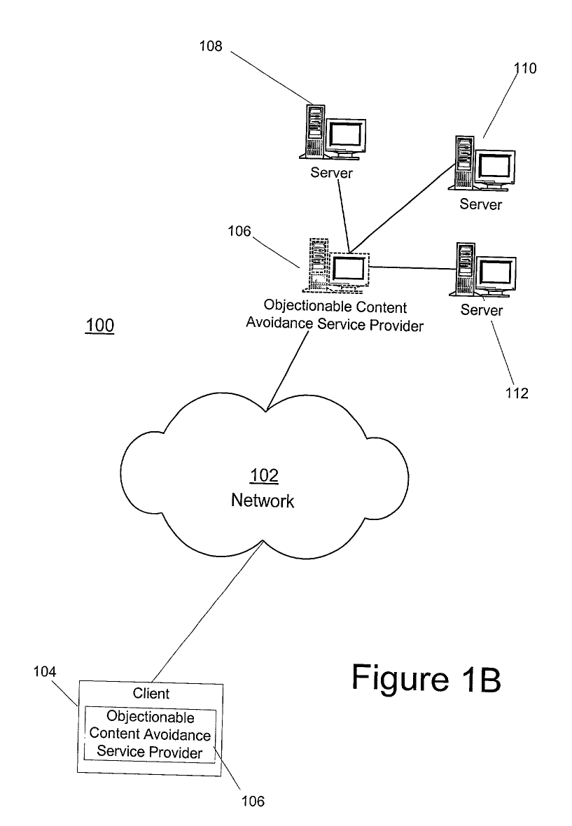

With reference now to the figures, FIG. 1A depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a servers 108-112 are connected to network 102 along with objectionable content avoidance service provider 106. In addition, client 104 is also connected to network 102. The client 104 may be, for example, a personal computer, network computer, personal digital assistant, portable computing device, or the like. In the depicted example, servers 108-112 provide data, such as files, web pages, operating system images, and applications to client 104. Client 104 is a client to servers 108-112. Network data processing system 100 may include additional servers, clients, service providers and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1A is intended as an example, and not as an architectural limitation for the present invention.

The objectionable content avoidance service provider 106, as will be described in more detail hereafter, provides a filtering mechanism by which content received from servers 108-112 is checked for objectionable content before being forwarded to client 104. The objectionable content avoidance service provider 106 may be implemented, for example, on a proxy server to which the client 104 is logged on (as shown), may be implemented as an application on the client 104, or as a network-resident service implemented by a proxy that resides on a service provider's premises through which servers 108-112 are accessed, or the like.

In the case of the objectionable content avoidance service provider 106 being implemented on the client 104, the objectionable content avoidance service provider 106 may be a stand alone software application, a portion of a web browser application, a plug-in to a web browser application, or the like. For purposes of illustration, it will be assumed in the following description that the objectionable content avoidance service provider 106 is implemented on a proxy server. The proxy server is present between the client and the server, and may either be logged onto by the client or a proxy of a service provider through which access to the servers 108-112 is obtained, as shown in FIG. 1B.

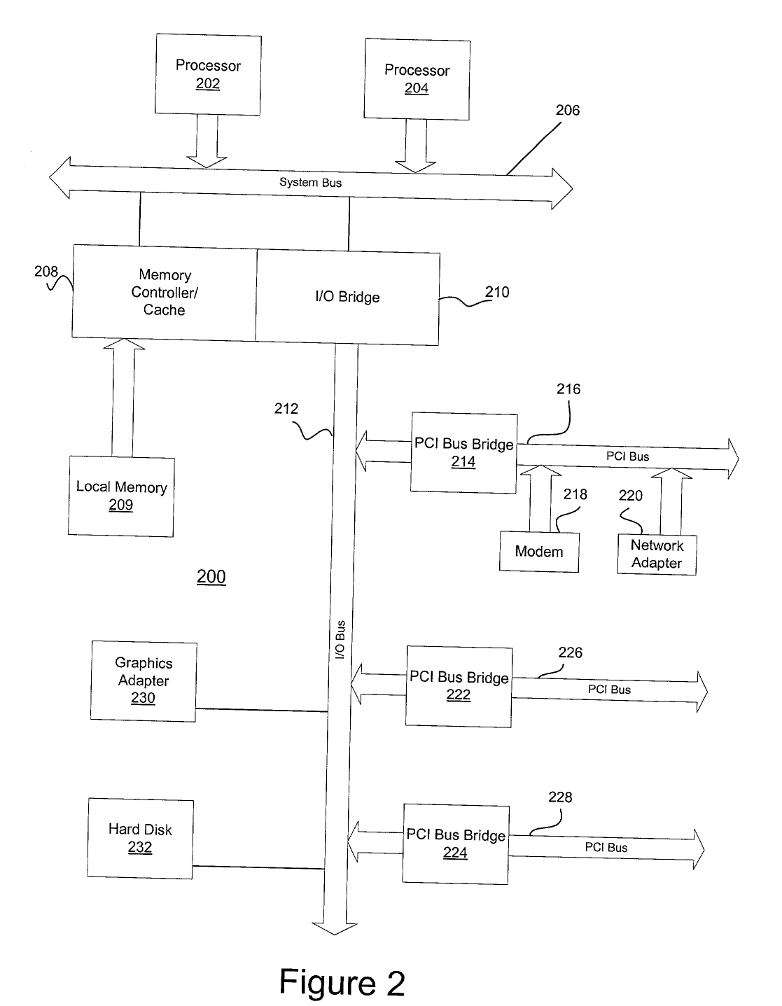

Referring to FIG. 2, a block diagram of a data processing system that may be implemented as a server, such as server 104 or a proxy server on which the objectionable content avoidance service provider 106 may be resident, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to P/O bus 212. Memory controller/cache 208 and P/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIGS. 1A and 1B may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

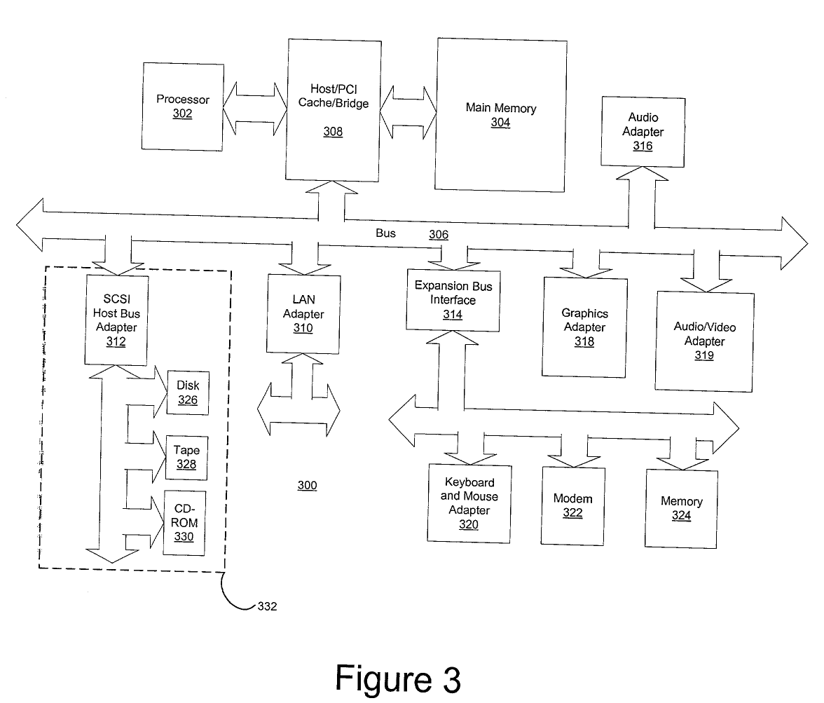

With reference now to FIG. 3, a block diagram illustrating a data processing system is depicted in which the present invention may be implemented. Data processing system 300 is an example of a client computer. Data processing system 300 employs a peripheral component interconnect (PCI local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programing system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

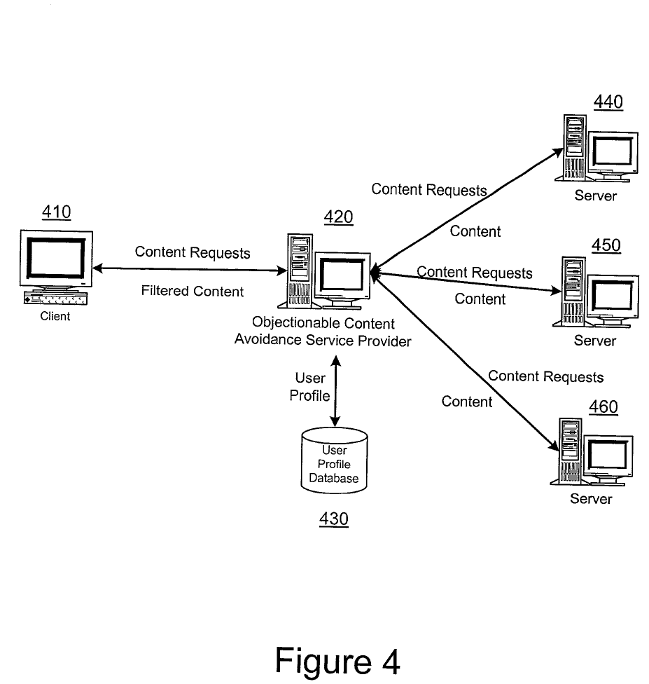

FIG. 4 is an exemplary block diagram illustrating the data flow according to the present invention. As shown in FIG. 4, the client 410 sends content requests to the objectionable content avoidance service provider 420 and receives filtered requested content from the objectionable content avoidance service provider 420. The objectionable content avoidance service provider 420 forwards content requests from the client 410 to the content servers 440-460 and receives requested content from the content servers 440-460. The objectionable content avoidance service provider 420 further retrieves user profile information from user profile database 430 for use in filtering the requested content received from the content servers 440-460, as described hereafter.

With the present invention, the client 410 issues requests for content to one or more of content servers 440-460 in a manner generally known in the art. For example, a user of client 410 may enter a Uniform Resource Locator (URL) associated with a Web page resident on content server 440 into a web browser application on the client 410. The entry of the URL into the web browser application causes the Web browser application to transmit a request for the Web page associated with the URL via a communication link to the objectionable content avoidance service provider 420. The content request from the client 410 is routed through the objectionable content avoidance service provider 420 which acts as a proxy server for the client 410.

Proxy servers are generally known in the art and are available for common Internet services. For example, an HTTP proxy is used for Web access, and an SMTP proxy is used for e-mail. Proxy servers generally employ network address translation (NAT), which presents one organization-wide IP address to the Internet. The proxy server funnels all user requests to the Internet and fans responses back out to the appropriate users. Proxies may also cache Web pages, so that the next request can be obtained locally.

The content request is forwarded to an appropriate content server 440-460 by the objectionable content avoidance service provider 420 via, for example, the network 102 in FIG. 1. The appropriate content server 440-460 is determined based on address information resident in headers of the data packets that make up the content request. The address information may be, for example, the Internet Protocol (IP) address associated with the URL input by the user of the client 410. The network 102 routes the content request from the objectionable content avoidance service provider 420 to the appropriate content server 440 based on this header information, as is generally known in the art.

The content server 440 receives the content request from the objectionable content avoidance service provider 420 and responds with the requested content. The requested content is transmitted back to the objectionable content avoidance service provider 420 as data packets via the network 102. The network 102 again routes the data packets of the requested content based on address information stored in headers of the data packets.

The objectionable content avoidance service provider 420 receives the requested content and performs various functions on the requested content. The functions may include known functions performed by proxy servers, such as firewall related functions, as well as analyzing the requested content to determine if it contains objectionable content.

The objectionable content avoidance service provider 420 may make use of any known or later developed algorithm for content analysis. For example, the objectionable content avoidance service provider 420 may make use of image analysis algorithms for determining if the requested content contains nudity. List based analysis may be used to block requested content from Web sites that are present in a site blocking list. Moreover, the objectionable content avoidance service provider 420 may perform textual analysis of the requested content to determine if profanity is present in the text of the requested content. Other mechanisms for analyzing the requested content for objectionable content may be used without departing from the spirit and scope of the present invention.

In one embodiment of the present invention, rather than relying on an analysis algorithm, the requested content may be rendered progressively on the client 410. That is, an image may first be presented at a very low resolution. Then, a dialog box may be provided that requests the user of the client 410 to indicate whether or not to continue to render the image in higher and higher resolution until the image is rendered at a normal resolution. Furthermore, the dialog box may provide a mechanism by which a user may designate that the image contains objectionable content. Thus, in this way, the user of the client 410 may directly indicate whether requested content is objectionable.

In a preferred embodiment, the determination of whether requested content contains objectionable content is based on a user profile stored in the user profile database 430. The user profile database 430 may be a separate device accessible by the objectionable content avoidance service provider 420 or may be incorporated within the objectionable content avoidance service provider 420. In an embodiment in which the objectionable content avoidance service provider 420 is resident on the client 410, the user profile database 430 may be a separate device accessible by the client 410 or may be incorporated within the client 410.

The user profile identifies levels of objectionable content which the user wishes to avoid. For example, the user profile may indicate categories of objectionable content that the user wishes to avoid, such as profanity, sexual content, violent content, nudity, and/or the like. The user profile may further provide thresholds related to each category by which an analysis function may determine if requested content is likely to be objectionable to the user. For example, if a user is less sensitive to the use of profanity than the use of nude imagery, the threshold for profanity may be set to a lower value than that for nudity. Similarly, if the user is less sensitive to violent content than sexual content, the user may set the threshold for violent content to be less than the threshold for sexual content.

These thresholds are preferably initially set when the user subscribes or registers with the objectionable content avoidance service provider 420. These thresholds, however, are preferably dynamically adjustable based on review of objectionable content by the user, as will be described in further detail hereafter.

With the preferred embodiment of the present invention, when requested content is received by the objectionable content avoidance service provider 420, the objectionable content avoidance service provider 420 scores the requested content based on an analysis of the requested content for objectionable content. For example, the requested content is analyzed to determine if profanity is included in the text, the type of profanity used (e.g., some profane words maybe more objectionable than others), and the extent of the profanity. A score may be given to the requested content based on the identification of profanity in the requested content. Thus, if the requested content includes a first profane term, the score for the requested content may be increased by two points for each occurrence of the first profane term. If the requested content includes a second profane term, the score for the requested content may be increased by one point for each occurrence of the second profane term.

Similarly, the score for the requested content may be increased based on the presence of nude images, sexually explicit or violent images or text, and the like. The resulting score for the requested content may then be compared against a threshold in the user profile to determine if the requested content will likely be objectionable to the user of the client 410. In addition, scores for each category of objectionable content may be maintained and compared against thresholds stored in the user profile. If one or more of these thresholds is exceeded, the requested content may be considered objectionable to the user. Alternatively, the present invention may have a requirement that a certain number of thresholds or certain ones of the thresholds be exceeded before the content is considered objectionable.

If the requested content is determined to contain objectionable content, the requested content maybe blocked from being provided to the client 410. In addition, if the requested content contains objectionable content, the requested content, or alternatively a link to the requested content, may be stored in an objectionable content data structure in the user profile for the user of the client 410. In addition, the scores for the requested content may also be stored in association with the requested content or link in the objectionable content data structure.

The objectionable content data structure may later be reviewed by the user, a parent of the user, an employer of the user, or the like, to determine whether or not the requested content determined to contain objectionable content is in actuality objectionable. When reviewing the objectionable content data structure, the user may designate a review threshold to identify a maximum objectionableness of the entries that the user wishes to review. In this way, the user is not required to review entries in the objectionable content data structure that are clearly objectionable to the user. Thus, only those entries in the objectionable content data structure that are tolerable by the user's sensitivities will be reviewed.

In reviewing the objectionable content data structure, if a user designates that the content is indeed objectionable, the thresholds of the user profile need not be adjusted since the thresholds adequately identified objectionable content. If however, the entry in the objectionable content data structure is identified as not being objectionable, the scores for that entry may be used to adjust the thresholds in the user profile. For example, if an entry in the objectionable content data structure contains profanity and is indicated as not being objectionable by the user, the threshold for profanity in the user profile may be adjusted accordingly.

The adjustment to the thresholds in the user profile based on a user's identification of an entry in the objectionable content data structure as being non-objectionable may be performed based on an algorithm, function, or the like. Thus, the adjustment may include setting the corresponding threshold(s) in the user profile to the scores for the entry in the objectionable content data structure. Alternatively, a functional relationship may be used to calculate new thresholds based on the scores for the entry in the objectionable content data structure. Moreover, an inference engine, neural network, expert system, or other intelligent computing system may be used to adjust the thresholds in the user profile based on the scores for the entry in the objectionable content data structure.

Thus, the present invention provides an apparatus and method by which objectionable content in requested content may be identified and blocked from being provided to an end user. In addition, the criteria by which the determination of objectionable content is made is dynamically updated based on a user's review of a historical list of prior requested content deemed to contain objectionable material.

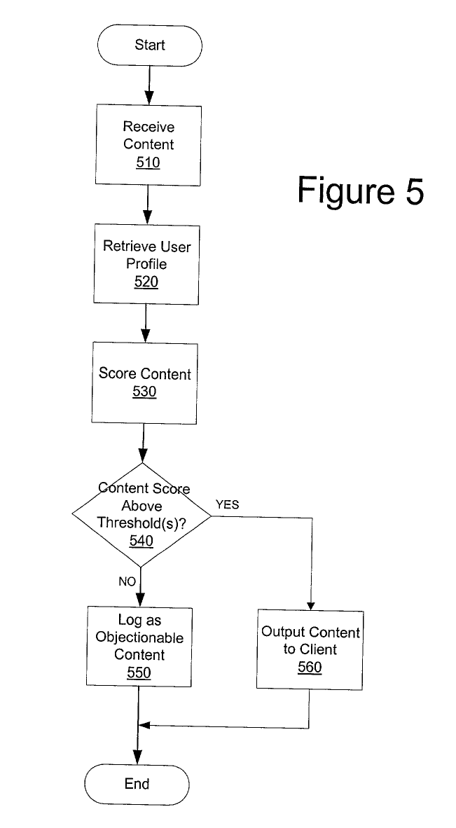

FIG. 5 is a flowchart outlining an exemplary operation of the present invention when determining if received content contains objectionable content. The operation outlined in FIG. 5 may be implemented in the objectionable content avoidance service provider 106 or 420 on either a proxy server or on the client device. As shown in FIG. 5, the operation starts with receiving the content (step 510). A user profile is retrieved (step 520) and a score is calculated for the content (step 530). A determination is made as to whether the content score is above the thresholds set forth in the user profile (step 540). If the content score is above the thresholds, the content is logged in an objectionable content data structure in the user profile (step 550). If the content score is not above the thresholds, the content is output to the client (step 560). The operation then ends.

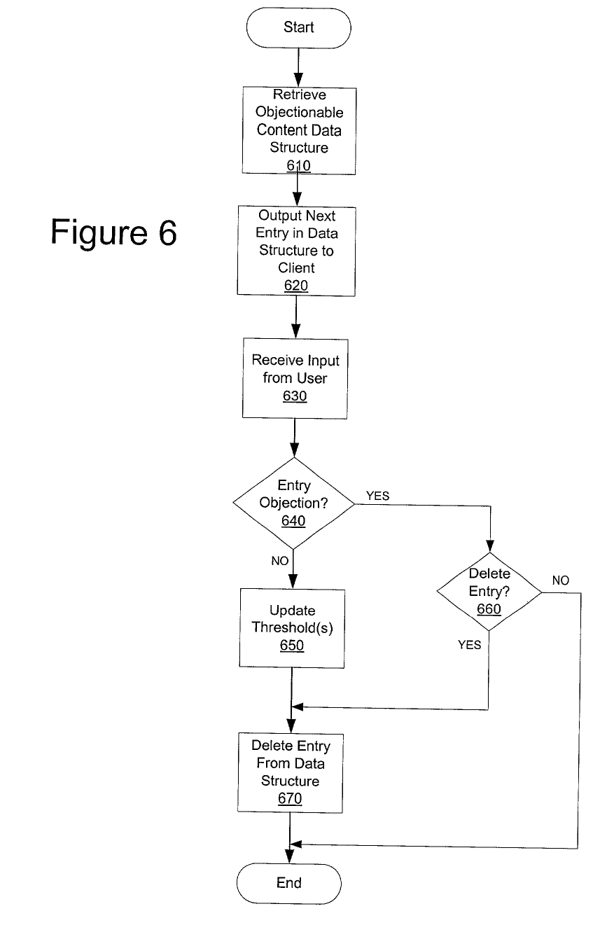

FIG. 6 is a flowchart outlining an exemplary operation of the present invention when a user is reviewing an objectionable content data structure in a user profile. The operation outlined in FIG. 6 may be implemented in the objectionable content avoidance service provider 106 or 420 on either a proxy server or on the client device.

As shown in FIG. 6, the operation starts with retrieving an objectionable content data structure from the user profile (step 610). The next entry in the objectionable content data structure is output to the client (step 620) and input from the user is received (step 630). As mentioned above, the next entry output to the client may be selected based on a review threshold defined by the user so that clearly objectionable entries are not output for review. In this way, the user is protected from reviewing content that is almost certainly objectionable to the user.

A determination is made as to whether the user has indicated the entry to be objectionable (step 640). If the entry is not objectionable, the thresholds in the user profile are updated (step 650) and the entry is deleted from the objectionable content data structure (step 670). If the entry is objectionable, a determination is made as to whether the entry should be deleted from the objectionable content data structure (step 660). This determination may be made based on whether the user indicates that the entry should be deleted or not. If the entry is to be deleted, the operation continues to step 670, otherwise the operation ends.

The present invention provides a mechanism by which objectionable content is identified in an active manner based on criteria defined by a user. The criteria is dynamically adjusted based on input from a user regarding whether content is objectionable or not. In this way, the present invention adapts to better approximate and predict whether subsequent requested content will be objectionable to the user.

The present invention makes use of analytical algorithms and input from a user to determine if requested content is objectionable in an active manner. Thus, the present invention need not be required to have complete knowledge of the content providers in order to determine if the content being provided contains objectionable content. The requested content is analyzed when received. Thus, the problems with prior art system regarding under-inclusiveness are minimized by the present invention.

With the present invention, the user is provided with an opportunity to review content that has been deemed to be objectionable to determine if the present invention is being over-inclusive. In this way, the user may dynamically adjust the criteria by which the present invention identifies objectionable content to provide a better predictor. Thus, the problems with the prior art systems regarding over-inclusiveness are minimized by the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of identifying objectionable content, comprising:
receiving requested content;
analyzing the requested content to identify an amount of objectionable content; and
storing the requested content in an objectionable content data structure if the amount of objectionable content in the requested content is above at least one predetermined threshold.

2. The method of claim 1, wherein the at least one predetermined threshold is obtained from a user profile.

3. The method of claim 1, further comprising:
providing at least one entry from the objectionable content data structure to a user;
receiving input from the user categorizing the at least one entry as objectionable or non-objectionable; and
adjusting the at least one predetermined threshold if the input from the user categorizes the at least one entry as non-objectionable.

4. The method of claim 1, wherein the method is implemented in a proxy server.

5. The method of claim 1, wherein the method is implemented in a client device.

6. The method of claim 1, wherein analyzing the requested content to identify an amount of objectionable content includes one or more of performing image analysis, performing list based analysis, performing textual analysis and receiving an input from a user designating the requested content as containing objectionable content.

7. The method of claim 1, wherein analyzing the requested content to identify an amount of objectionable content includes using parameters stored in a user profile to identify objectionable content.

8. The method of claim 7, wherein the user profile identifies levels of objectionable content which a user wishes to avoid.

9. The method of claim 7, wherein the user profile identifies the at least one threshold for one or more categories of objectionable content.

10. The method of claim 1, wherein the at least one threshold is dynamically adjustable.

11. The method of claim 10, wherein the at least one threshold is dynamically adjustable based on results of review, by a user, of objectionable content in the objectionable content data structure.

12. The method of claim 1, wherein analyzing the requested content to identify an amount of objectionable content includes scoring the requested content based on the amount and type of objectionable content contained in the requested content.

13. The method of claim 12, wherein scoring the requested content based on the amount and type of objectionable content contained in the requested content includes maintaining scores for each of a plurality of categories of objectionable content.

14. The method of claim 13, wherein analyzing the requested content to identify an amount of objectionable content further includes determining if one or more of the scores for each of the plurality of categories of objectionable content exceeds the at least one threshold.

15. The method of claim 14, wherein the threshold is defined in a user profile.

16. The method of claim 3, wherein adjusting the at least one predetermined threshold if the input from the user categorizes the at least one entry as non-objectionable includes determining a new value for the at least one predetermined threshold using one of an algorithm, a function, an inference engine, a neural network, an expert system and an intelligent computing system.

17. An apparatus for identifying objectionable content, comprising:
a first interface which receives requested content;
a processor which analyzes the requested content to identify an amount of objectionable content; and
a storage device which stores the requested content in an objectionable content data structure if the amount of objectionable content in the requested content is above at least one predetermined threshold.

18. The apparatus of claim 17, wherein the at least one predetermined threshold is obtained from a user profile.

19. The apparatus of claim 17, further comprising:
a second interface which provides at least one entry from the objectionable content data structure to a client device; and
a third interface which receives input from a user categorizing the at least one entry as objectionable or non-objectionable, wherein the processor adjusts the at least one predetermined threshold if the input from the user categorizes the at least one entry as non-objectionable.

20. The apparatus of claim 17, wherein the apparatus is a proxy server.

21. The apparatus of claim 17, wherein the apparatus is a client device.

22. The apparatus of claim 17, wherein the processor performs one or more of image analysis, list based analysis, and textual analysis to identify an amount of objectionable content.

23. The apparatus of claim 17, wherein the processor uses parameters stored in a user profile to identify an amount of objectionable content.

24. The apparatus of claim 23, wherein the user profile identifies levels of objectionable content which a user wishes to avoid.

25. The apparatus of claim 23, wherein the user profile identifies the at least one threshold for one or more categories of objectionable content.

26. The apparatus of claim 17, wherein the at least one threshold is dynamically adjustable.

27. The apparatus of claim 17, wherein the at least one threshold is dynamically adjustable based on results of review, by a user, of objectionable content in the objectionable content data structure.

28. The apparatus of claim 17, wherein the processor scores the requested content based on the amount and type of objectionable content contained in the requested content.

29. The apparatus of claim 28, wherein the processor maintains scores for each of a plurality of categories of objectionable content.

30. The apparatus of claim 29, wherein the processor determines if one or more of the scores for each of the plurality of categories of objectionable content exceeds the at least one threshold.

31. The apparatus of claim 30, wherein the threshold is defined in a user profile.

32. The apparatus of claim 19, wherein the processor determines a new value for the at least one predetermined threshold using one of an algorithm, a function, an inference engine, a neural network, an expert system and an intelligent computing system.

33. A computer program product in a computer readable medium for identifying objectionable content, comprising:
first instructions for receiving requested content;
second instructions for analyzing the requested content to identify an amount of objectionable content;
third instructions for storing the requested content if the amount of objectionable content in the requested content is above at least one predetermined threshold.

34. The computer program product of claim 33, wherein the at least one predetermined threshold is obtained from a user profile.

35. The computer program product of claim 33, further comprising:
fourth instructions for providing at least one entry from the objectionable content data structure to a user;
fifth instructions for receiving input from the user categorizing the at least one entry as objectionable or non-objectionable; and
sixth instructions for adjusting the at least one predetermined threshold if the input from the user categorizes the at least one entry as non-objectionable.

36. The computer program product of claim 33, wherein the computer program product is executed in a proxy server.

37. The computer program product of claim 33, wherein the computer program product is executed in a client device.

38. The computer program product of claim 33, wherein the second instructions for analyzing the requested content to identify an amount of objectionable content includes instructions for performing one or more of image analysis, list based analysis, and textual analysis.

39. The computer program product of claim 33, wherein the second instructions for analyzing the requested content to identify an amount of objectionable content includes instructions for using parameters stored in a user profile to identify objectionable content.

40. The computer program product of claim 39, wherein the user profile identifies levels of objectionable content which a user wishes to avoid.

41. The computer program product of claim 39, wherein the user profile identifies the at least one threshold for one or more categories of objectionable content.

42. The computer program product of claim 33, wherein the at least one threshold is dynamically adjustable.

43. The computer program product of claim 33, wherein the at least one threshold is dynamically adjustable based on results of review, by a user, of stored objectionable content.

44. The computer program product of claim 33, wherein the second instructions for analyzing the requested content to identify an amount of objectionable content includes instructions for scoring the requested content based on the amount and type of objectionable content contained in the requested content.

45. The computer program product of claim 44, wherein the instructions for scoring the requested content based on the amount and type of objectionable content contained in the requested content includes instructions for maintaining scores for each of a plurality of categories of objectionable content.

46. The computer program product of claim 45, wherein the second instructions for analyzing the requested content to identify an amount of objectionable content further includes instructions for determining if one or more of the scores for each of the plurality of categories of objectionable content exceeds the at least one threshold.

47. The computer program product of claim 46, wherein the threshold is defined in a user profile.

48. The computer program product of claim 35, wherein the sixth instructions for adjusting the at least one predetermined threshold if the input from the user categorizes the at least one entry as non-objectionable includes instructions for determining a new value for the at least one predetermined threshold using one of an algorithm, a function, an inference engine, a neural network, an expert system and an intelligent computing system.
